(19) United States
(12) Patent Application Publication
(10) Pub. No.: US 2003/0002689 A1
(43) Pub. Date: Jan. 2, 2003

(54) Supplemental audio content system with wireless communication for a cinema and related methods

(75) Inventor: Richard J. Folio, Melbourne, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Harris Corporation, Melbourne, FL

(21) Appl. No.: 09/896,894

(22) Filed: Jun. 29, 2001

(51) Int. Cl. H04B 3/00

(52) U.S. Cl. 381/77; 381/2

(57) ABSTRACT

A supplemental audio content system is for providing supplemental audio content to movie patrons during playing of a motion picture film and associated soundtrack in a cinema of cineplex including a plurality of individual cinemas. The system may include a player for playing supplemental audio content during playing of the motion picture and associated soundtrack, and a wireless transmitter connected to the supplemental audio content player. An earphone may be worn by the movie patron, and the earphone may be connected to a wireless receiver to cooperate with the wireless transmitter to deliver supplemental audio content to the at least one movie patron. The wireless transmitter and wireless receiver preferably have operating characteristics to avoid interference with respective supplemental audio content systems for other cinemas of the cineplex.

### FIELD OF THE INVENTION

The present invention relates to entertainment systems and methods, and more particularly, to supplemental audio content systems and methods for cinemas of a cineplex.

### BACKGROUND OF THE INVENTION

Motion pictures are commonly shown in cineplexes which include up to twenty or more individual cinemas. Each cinema includes a movie patron seating area, a projection screen and a projector for displaying the motion picture on the screen. Sound systems are also highly developed, and multi-channel soundtracks are typically played along with the motion picture. The soundtrack information in the past has been provided typically from analog tracks adjacent the motion picture frames of the film. A number of cinemas still use these analog soundtracks, however, equipment to provide higher quality digital soundtracks has also been developed and is in use.

For example, U.S. Pat. No. 6,072,760 to Shirasu, discloses the Sony Digital Dynamic Sound technology wherein an S track is provided to the left of the left perforations and a P track is provided to the right of the right perforations of the motion picture. The sound information is thus digitally encoded as a pattern of rectangular dots or pits 22.5 microns by 24 microns.

U.S. Pat. No. 6,211,940 B1 discloses motion picture film wherein digital sound information is stored in the space between a line or perforations on the same side of the film as the analog audio soundtrack. Since the information may be lost due to wear or mechanical damage, the system may select the analog track if the digital information is corrupted.

Along these lines, U.S. Pat. No. 5,386,255 to Beard et al. discloses a digital sound system for motion picture films wherein a digital time code is provided on the film. The digital time code is read during playing of the film, and, together with zero crossing data from the power line, is used to synchronize a digital soundtrack stored on an compact disk or digital audio tape. Accordingly, the film can be played back in theaters using either the analog or digital sound tracks.

U.S. Pat. No. 5,055,939 to Karamon et al. discloses another approach to compatibility for analog and digital formats. More particularly, the patent discloses an approach that does not require synchronizing tracks, codes, markers or time codes or other extrinsic data to be recorded on the film. Instead the standard audio itself, from the film, provides the information that controls the timing of the higher quality auxiliary sound source.

Although many approaches to supplemental audio are directed toward providing a higher quality soundtrack, the Karamon et al. patent, for example, also discloses that alternate languages can be synchronized to the higher quality auxiliary sound source. These translations would be available for selection for listening by a cinema audience or by segments of the audience sitting in preselected seating areas having listening devices assigned to respective languages.

Another category of supplemental audio content is offered under the TheatreVision program created by the founding president of RP International, a non-profit organization fighting retinitis pigmentosa (RP), and other blinding, degenerative eye diseases. TheatreVision makes films accessible to the visually challenged by incorporating a special soundtrack for feature films that runs concurrently with the dialogue of the picture. This track provides a descriptive narration of what is being shown on the screen, so that those without sight can still experience the medium of motion pictures. Over the next few years, plans call for these special narrative tracts to be heard via headsets in theaters all over the United States.

As motion picture technology continues to progress, there are plans for distribution and presentation of motion picture entertainment entirely in digital format, that, is, without the current film with frames, etc. Unfortunately, a typical motion picture may require terabytes of digital data. Moreover, digital projectors are very costly and still may require further technical development to be more compatible with existing film-based projectors. Accordingly, migration to an all-digital format may be many years away. An all digital approach may readily accommodate supplemental audio content which can be stored along with the picture data and main soundtrack data. In the meantime, however, supplemental audio content distribution and presentation in cinemas is severely hampered and complicated by requiring compatibility with existing motion picture film equipment and formats. Moreover, delivery of the supplemental audio content to only selected movie patrons within a cinema may also be difficult, especially where adding wiring throughout the cinema may be cost prohibitive.

### SUMMARY OF THE INVENTION

In view of the foregoing background, it is therefore an object of the present invention to provide a system and method for efficiently and economically providing supplemental audio content to movie patrons in cinemas using motion picture film.

This and other objects, features and advantages in accordance with the present invention are provided by a supplemental audio content system for providing supplemental audio content to at least one movie patron during playing of a motion picture film and associated soundtrack in a cinema of cineplex comprising a plurality of individual cinemas. In particular, the supplemental audio content system may comprise a supplemental audio content player for playing supplemental audio content during playing of the motion picture and associated soundtrack, and a wireless transmitter connected to the player.

At least one earphone may be provided to be worn by the at least one movie patron, and the system may also include at least one wireless receiver connected to the at least one earphone and cooperating with the wireless transmitter to deliver supplemental audio content to the at least one movie patron. Moreover, the wireless transmitter and wireless receiver may preferably have operating characteristics to avoid interference with respective supplemental audio content systems for other cinemas of the cineplex. Accordingly, the supplemental audio content system may be readily used in many modern cineplexes without requiring extensive rewiring and without having undesired interference between adjacent cinemas within the cineplex.

The supplemental audio content may comprise spoken words devoid of music and sound effects. For example, the supplemental audio content may comprise alternate language audio content, or may comprise descriptive narrative audio content, such as to aid the sight impaired.

The wireless transmitter may use digital modulation, that is, include a digital modulator, and the at least one wireless receiver may also use digital demodulation, that is, include a digital demodulator. For example, in one particularly advantageous class of embodiments, the wireless transmitter may use spread spectrum modulation, and the at least one wireless receiver may use spread spectrum demodulation. The spread spectrum modulation/demodulation may be either direct sequence or frequency hopping, for example.

In another class of embodiments, the wireless transmitter and the at least one wireless receiver may use at least one selectable channel. For example, the at least one selectable channel may comprise at least one selectable radio frequency channel. Accordingly, interference may be readily avoided between adjacent cinemas in the cineplex by proper selection of the frequency channels of the supplemental audio content systems in adjacent cinemas.

In some embodiments, the wireless transmitter may comprise a radio frequency RF transmitter, and the at least one wireless receiver may include at least one RF receiver. The RF transmitter and at least one RF receiver may also preferably operate in an unlicensed RF band in some embodiments. For example, the unlicensed band may be in a range of about 2.400 to 2.4835 GHz, although other bands are also possible.

In other embodiments, the wireless transmitter may comprise an infrared transmitter, and the at least one wireless receiver may comprise at least one infrared receiver. The infrared signals will not penetrate the walls of the cinema so that interference with adjacent systems is readily avoided.

The at least one wireless receiver may comprise a respective wireless receiver for each earphone. In other words, the earphone and wireless receiver may define a movie patron unit to be used by the movie patron. In addition, the movie patron unit may include an earphone level control connected to the earphone to permit the patron to select an appropriate listening level.

The at least one earphone may comprise at least one open field earphone. Accordingly, the movie patron can hear the music, sound effects, dialogue, etc. of the movie soundtrack along with the supplemental audio content. The supplemental audio content player may comprise a storage device for storing the supplemental audio content, and a processor for reading the supplemental audio content from the storage device during playing of the motion picture and associated soundtrack.

A method aspect of the invention is for delivering supplemental audio content to at least one movie patron during playing of a motion picture film and associated soundtrack in a cinema of cineplex comprising a plurality of individual cinemas. The method may include providing at least one movie patron unit comprising an earphone and a wireless receiver connected thereto, and wirelessly transmitting the supplemental audio content from a wireless transmitter to the at least one movie patron unit to thereby deliver supplemental audio content to the at least one movie patron. Moreover, the wireless transmitter and wireless receiver may have operating characteristics to avoid interference with respective supplemental audio content systems for other cinemas of the cineplex.

### BRIEF DESCRIPTION OF THE DRAWINGS

FIG. 1 is a schematic plan view of a cineplex illustratively including four cinemas, each cinema including the supplemental audio content system in accordance with the present invention.

FIG. 2 is a schematic diagram of the supplemental audio content system and related equipment as shown in FIG. 1 for two cinemas.

FIG. 3 is a more detailed schematic diagram of a portion of the supplemental audio system as shown in FIG. 2.

FIG. 4 is a perspective view of an embodiment of a movie patron unit of the supplemental audio system as shown in FIG. 2.

FIG. 5 is a schematic diagram of a wireless transmitter and receiver as may be used in the supplemental audio system of FIG. 2.

FIG. 6 is a schematic diagram of another wireless transmitter and receiver as may be used in the supplemental audio system of FIG. 2.

FIG. 7 is a schematic diagram of yet another wireless transmitter and receiver as may be used in the supplemental audio system of FIG. 2.

### DETAILED DESCRIPTION OF THE PREFERRED EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notation are used to indicate similar elements in alternate embodiments.

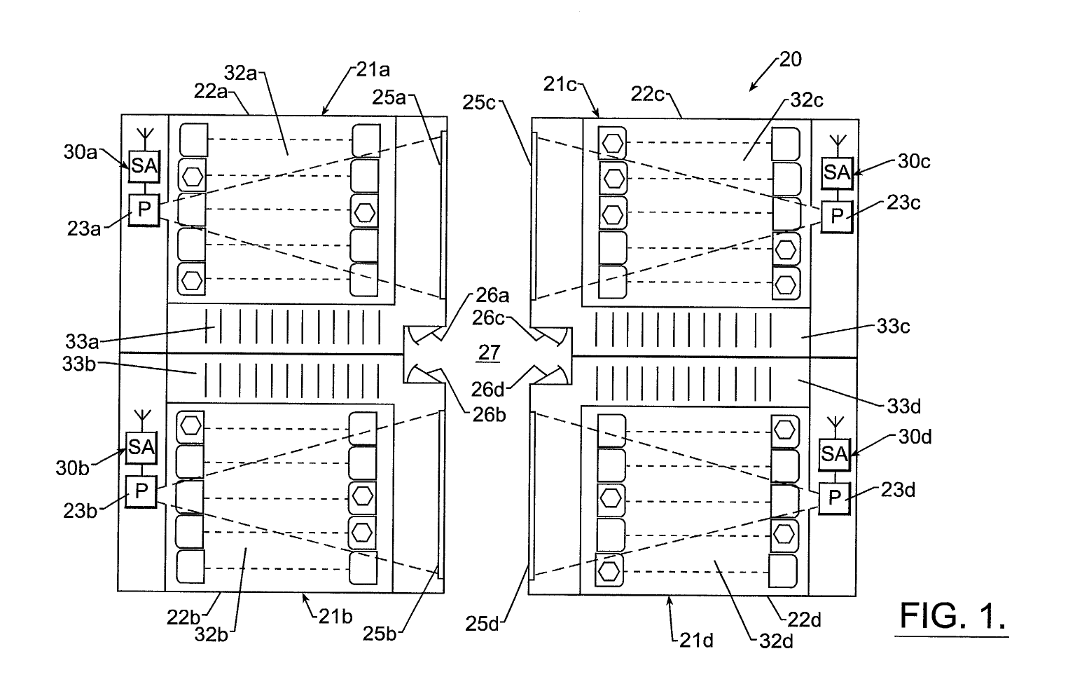

Referring initially to FIG. 1, the supplemental audio content system in accordance with the present invention may be used in a cineplex 20 including a plurality of individual cinemas 21a-21d. Indeed, in the illustrated embodiment of the cineplex 20, each of the cinemas 21a-21d includes a respective supplemental audio content system 30a-30d. Each of the supplemental audio content systems 30a-30d is connected to a respective movie film projector 23a-23d. In other embodiments, not all of the cinemas 21a-21d need be so equipped as will be appreciated by those skilled in the art. The number of cinemas 21 in a cineplex 20 may vary, with twenty or more cinemas not uncommon.

Each of the cinemas 21a-21d includes a respective room 22a-22d with a screen 24a-24d at the forward wall thereof to display the projected movie image. The rooms 22a-22d illustratively include doors 26a-26d which open into a common hallway. Stairs 33a-33d lead alongside the illustrated seating areas 32a-32d as will be appreciated by those skilled in the art. Of course, other room and seating configurations are possible and contemplated by the present invention.

A number of the movie patrons may be interested in some form of supplemental audio content, such as the descriptive narrative audio to aid the sight-impaired, and/or alternative language audio. Accordingly, the hexagons in FIG. 1 are used to schematically indicate those movie patrons using the supplemental audio content system, such as by using the movie patron unit 50 as will be described in greater detail below.

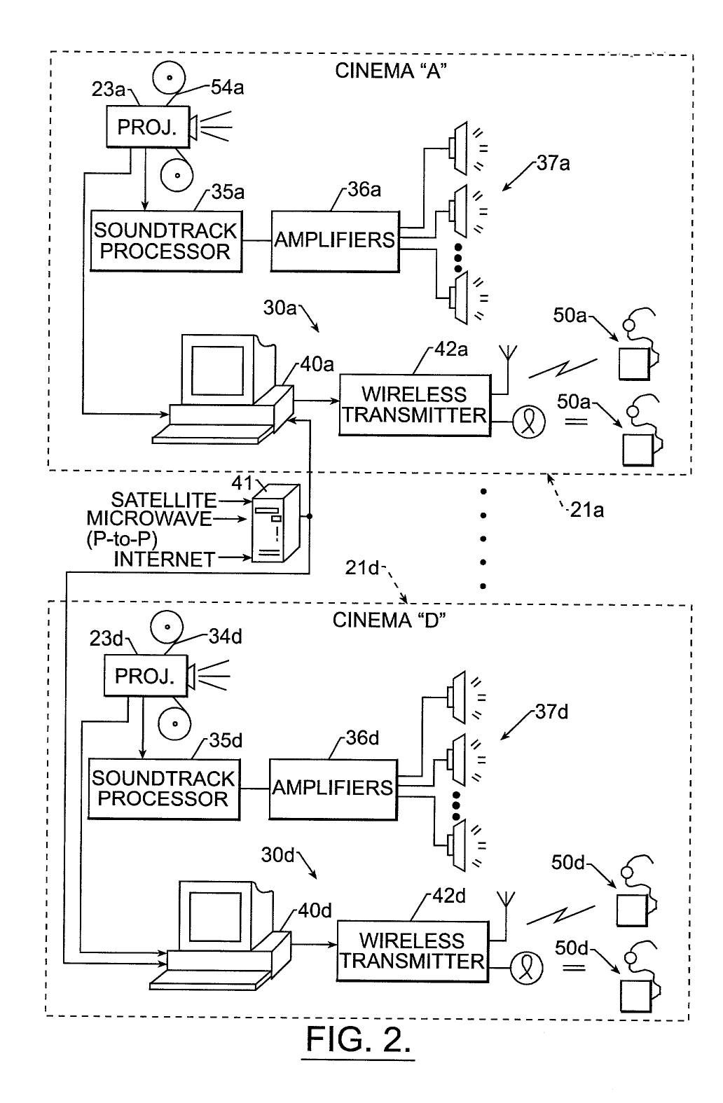

Referring now additionally to FIG. 2, further details of the respective supplemental audio content systems and other related equipment for two of the cinemas 21a, 21d are now described. Each cinema 21a, 21d includes a projector 23a, 23d for playing a respective motion picture film 34a, 34d.

Each projector 23a, 23b may of the type that uses DOLBY® processing to produce a bitstream of identification data during playing. In particular, the identification information may include at least one of a reel identification, a frame identification, and a frame portion identification. For example, the reel may be identified with a number, such as reel 6, and the frame and frame portion may be identified with a continuous running number count or film block number. In view of the typical number of frames, and since each frame may be divided into four portions, the block number may range from 0 to about 260,000, depending on the length of the motion picture.

Digital data packets may be encoded in twodimensional blocks, with four blocks for each picture frame, for example, on the film. Since twenty-four frames are commonly shown per second, 96 data packets are output per second. Each data packet may include 32 bytes of identification information. Further details regarding the two-dimensional encoding and reading are disclosed in U.S. Pat. No. 6,211,940, the entire contents of which are incorporated herein by reference. Of course, those of skill in the art will appreciate that other data formats are also contemplated by the invention.

The respective digitally encoded soundtrack information may be processed by the soundtrack processors 35a, 35d. The soundtrack processors 35a, 35d, in turn are connected to respective amplifiers 36a, 36d which drive the sets of speakers 37a, 37d in the cinemas 21a, 21d. These components are conventional and need no further discussion herein.

In the illustrated embodiment, a supplemental audio content player in the form of a personal computer 40a, 40d is provided in each cinema 21a, 21d, such as in the projection room, for example, and as part of the supplemental audio content system 30a, 30d. As will be described in greater detail below, the personal computers 40a, 40d may be used in some embodiments to provide the signal processing to synchronize playing of the respective supplemental audio content with the playing of the motion picture film 34a, 34d.

The personal computers 40a, 40d are also illustratively connected to a common server 41. The common server 41 may be used to receive the supplemental audio content via the Internet in some embodiments. This content pushed via the Internet may be stored on the server 41 for later playing, or may be preprocessed and stored as described in greater detail below.

The supplemental audio content can also be received via satellite distribution (point-to-multipoint) or via a point-to-point communications link, eg. microwave link, as also schematically illustrated. Of course, in other embodiments, the server 41 may acquire the supplemental audio content as data stored on digital disks, digital tapes, or other similar physically transported media.

The server 41 is illustratively connected to each of the projection room personal computers 40a, 40d, such as via a wired or wireless local area network (LAN) as will be readily appreciated by those skilled in the art. As will also be appreciated by those skilled in the art, the server 41 may not be needed in other embodiments.

One important aspect is that the supplemental audio content signals during playing can be distributed or delivered to movie patrons in the cinema via a wireless communications link. More particularly, as schematically shown in FIG. 2, each personal computer 40a, 40d may be connected to a respective wireless transmitter 42a, 42d. The wireless transmitters 42a, 42d then communicate with corresponding wireless receivers in the respective movie patron units 50a, 50d as will also be described in greater detail below. The wireless link may be infrared or radio frequency (RF) as also described in greater detail below. These approaches may be employed to reduce the likelihood of interference between adjacent cinemas 21a-21d in the cineplex 20.

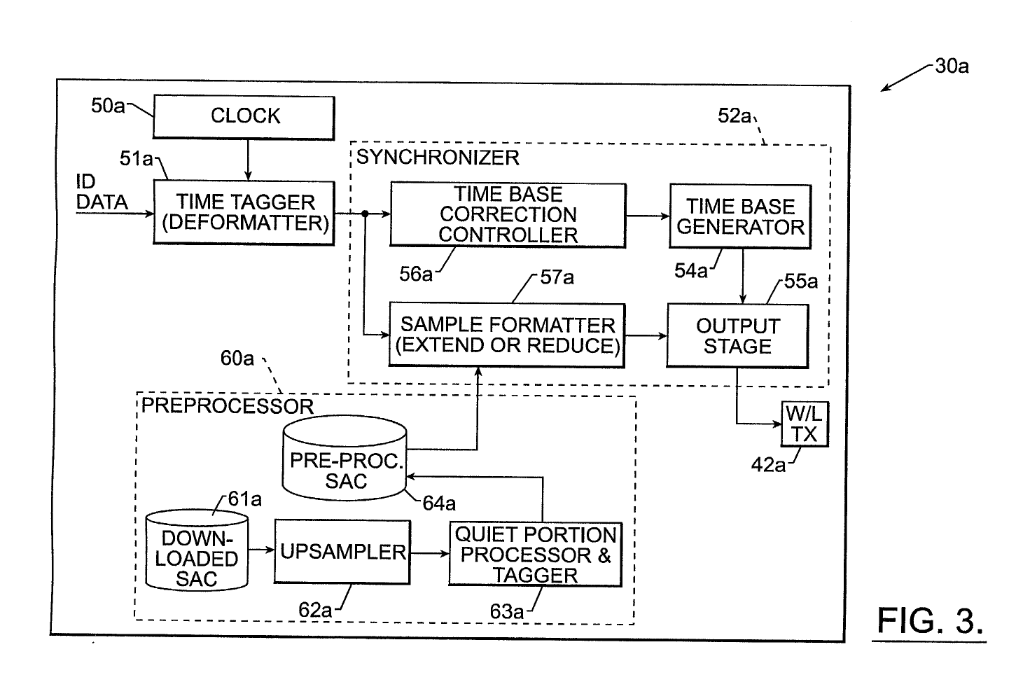

Referring now additionally to FIG. 3, various processing steps and portions of a supplemental audio content system 30a are now described. For clarity of explanation, only a single system 30a will be described in detail, and those of skill in the art will recognize that the other systems in the cineplex 20 may the same or similar.

The system 30a includes a clock 50a connected to the time tagger 51a. The clock 50a may be the clock or the personal computer 40a or derived therefrom, as such provides an accurate “wall clock” source for further processing. The time tagger 51a deformats the identification data packets output from the projector 23a. The time tagger 51a also time tags or associates with the data, a time based upon the clock 50a. In other words, the time tagger 51a cooperates with the clock 50a for generating time tagged identification data based upon the identification data from the motion picture film 34a during playing thereof.

The time tagger 51a is illustratively connected to a synchronizer 52a for synchronizing playing of the supplemental audio content with playing of the motion picture film 34a and associated soundtrack and based upon the time tagged identification data. More particularly, the synchronizer 52a may play the supplemental audio content at a play rate based upon the time tagged identification data to synchronize with playing of the motion picture film. In addition, the synchronizer 52a may also skip ahead or wait while playing the supplemental audio content based upon the time tagged identification data to synchronize with playing of the motion picture film. Skipping ahead, for example, may be desired where splices have been made to the motion picture film and a number of frames have been deleted, as will be appreciated by those skilled in the art.

To perform these functions, the synchronizer 52a may include a time base generator 54a for generating a time base signal based upon the time tagged identification data, and an output stage 55a for playing the supplemental audio content at a rate based upon the time base signal from the time base generator 54a. To improve synchronization, the illustrated synchronizer 52a also further comprises a time base correction controller 56a for adjusting the time base generator 54a based upon the time tagged identification data. In other words, the time base correction controller 56a may provide feedback control to follow the rate of playing of the motion picture film 34a which can vary. The playing rate may be varied slightly without causing undesired changes in pitch of supplemental audio content as will be appreciated by those skilled in the art.

Turning now to the bottom portion of FIG. 3, preprocessing steps as may enhance synchronization are now described. Such preprocessing may be performed by the preprocessor 60a. The preprocessor 60a may be implemented in the server 41 (FIG. 2) or in the personal computer 40a, or the functions may be shared, as will be appreciated by those skilled in the art. The preprocessing may also be performed by the originating source prior to delivery to the cineplex 20 in other embodiments.

The illustrated preprocessor 60a is for preprocessing the supplemental audio content to identify quiet portions between adjacent live portions. Since the supplement audio content is preferably spoken words, e.g. dialogue or descriptive narration, there are typically pauses between words, or between phrases or sentences. These pauses, for example, define quiet portions which can be extended or reduced in order to aid synchronization during playing. As an example, a quiet portion may be identified as occurring between reel X, and between block numbers Y and Y+75. Of course, quiet portions can be considerably longer or shorter as will be appreciated by those skilled in the art.

Once identified during preprocessing and associated with the identification information that is also used on the motion picture film or which can be correlated therewith, these quiet portions can be extended or reduced by the illustrated sample formatter 57a. Of course, by reduced is also meant to include the complete reduction or elimination of a quiet portion, and extended is meant to cover the creation of a quiet portion. To reduce noise which may otherwise be generated, the sample formatter 57a may hold a prior sample during extension of a quiet portion as will be appreciated by those skilled in the art.

The preprocessor 60a illustratively includes a first memory 61a for storing the downloaded supplemental audio content. The supplemental audio content is upsampled in the illustrated upsampler 62a to match the desired play sample rate. The supplemental audio content is then processed to determine quiet portions and their locations in the illustrated quiet portion processor and tagger 63a. This quiet portion processor and tagger 63a can be provided by the microprocessor of the portable computer 40a of the projection area, or the common server 41 as will be appreciated by those skilled in the art. This preprocessed supplemental audio content may then be stored in the second memory 64a for use during playing. This second memory 64a may typically be the hard drive of the portable computer 40a associated with the projection room. Of course, the preprocessed supplement audio content can also be stored in the first memory along with the downloaded content, or in place of the downloaded content.

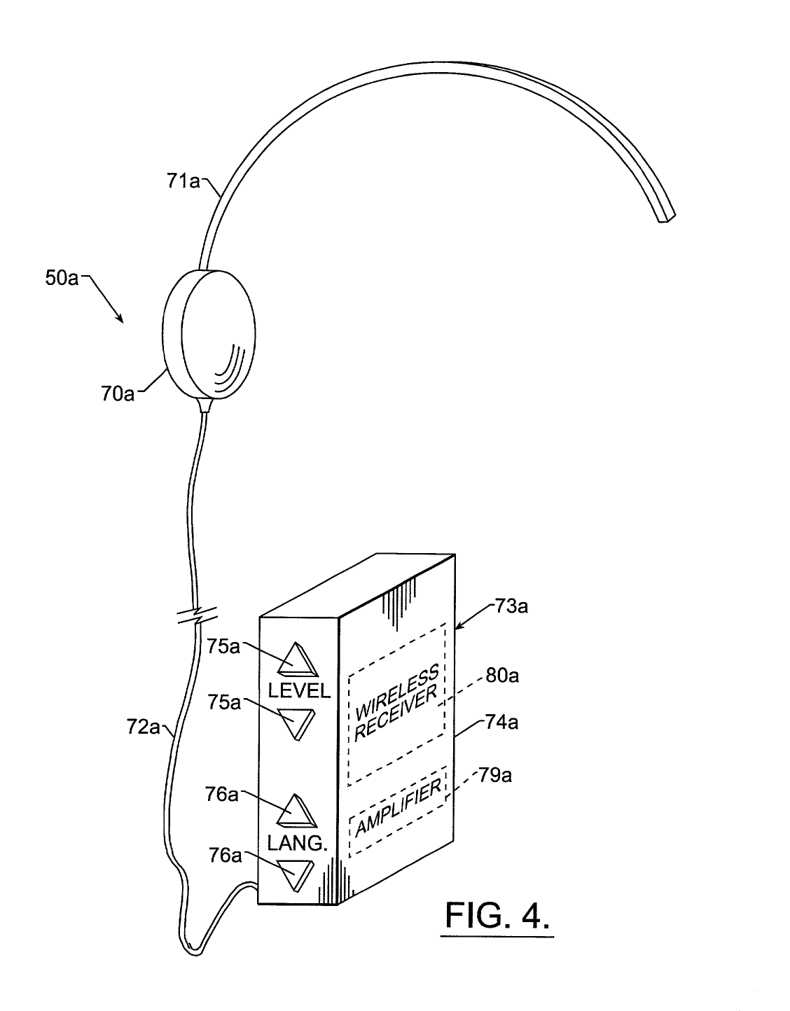

Turning now to FIG. 4, a movie patron unit 50a for the supplemental audio content system 30a is now described. The movie patron unit 50a delivers the supplemental audio content to the movie patron. The illustrated movie patron unit 50a includes an earphone 70a connected to a headband 71a to be worn on the head of the movie patron. In other embodiments, a pair of earphones may be provided. Also, the headband 71a may not be needed in other embodiments where the earphone 70a is otherwise attachable adjacent the movie patron's ear. The earphone 70a may be an open field earphone that allows the patron to hear the music, sound effects, main dialogue, etc. from the main soundtrack, while also hearing the supplemental audio content from the earphone.

The earphone 70a is connected to an associated device 73a via a cable 72a. The device 73a may include a housing 74a containing associated electronics, such as an amplifier 79a and may also carry level setting switches 75a on a portion of the housing. A battery, not shown, may also be carried by the housing 74a. Where the supplemental audio content is an alternate language, selector switches 76a may be used to allow the movie patron to select the desired alternate language. In other embodiments, the device 73a may be constructed or arranged together with the earphone 70a, such as part of a headset, for a more compact arrangement.

In some other embodiments, such as for construction of a new cinema, wiring may be run to each movie seating position, so that the movie patron unit 50a may be a simple headset which plugs into a suitable jack at the seating position. It should be recognized by those skilled in the art, however, that retrofitting such extensive wiring to an existing cinema may be cost prohibitive. Accordingly, another aspect of the supplemental audio content system 30a is that a wireless communications link may be used instead of wired links to each movie seat position. Thus, the device 73a may include a wireless receiver 80a carried within the housing 74a as will be described in greater detail below. Moreover, since motion pictures are typically now shown in cineplexes 20 including multiple cinemas 21a-21d, it is also highly desirable that interference be suppressed between adjacent systems using wireless communications links.

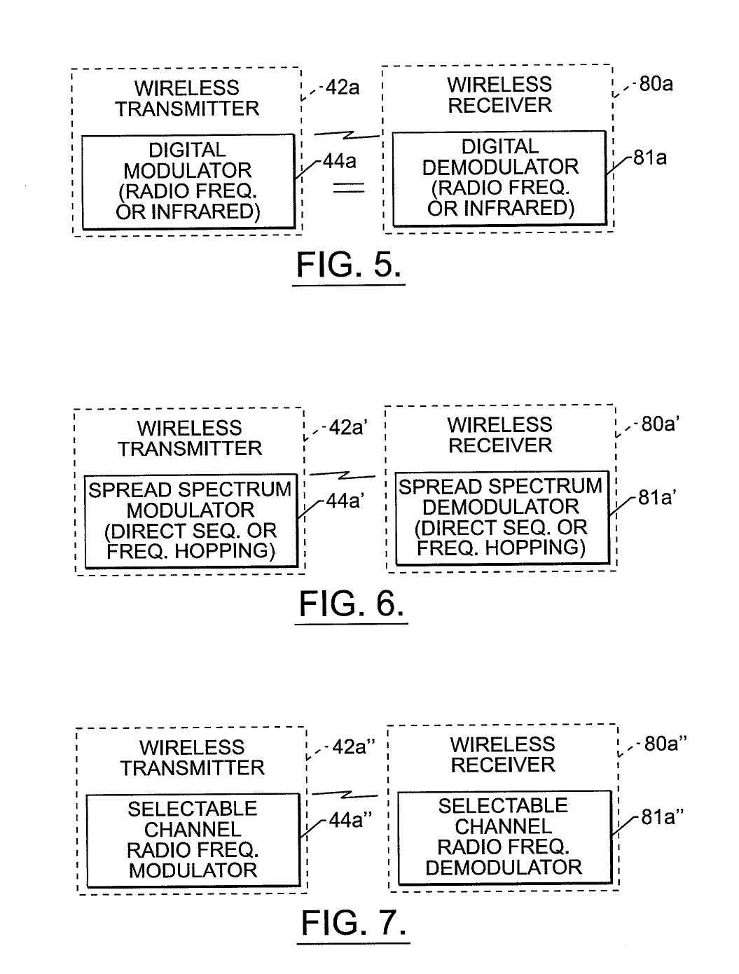

Referring now additionally to FIGS. 5-7, various embodiments of wireless transmitters and receivers for implementing wireless communications links are now described. In particular as shown in FIG. 5, to reduce interference, the wireless transmitter 42a may include a digital modulator 44a. Correspondingly, the wireless receiver 80a may include a digital demodulator 81a. For example, the digital modulator and demodulator may operate over radio frequency bands or in the infrared band.

Infrared operation offers the advantage that infrared radiation will not pass through the walls of the cinema, therefore interference with adjacent cinemas is prevented. However, delivering the infrared signals within the cinema requires that there be no substantial blockage between the transmitter and each receiver.

RF operation offers the advantage over infrared of being less susceptible to blockage of a direct path between the transmitter and the receivers; however, RF operation may be more susceptible to interference. The digital modulation may offer advantages in avoiding interference, especially, for example, where spread spectrum modulation is used, as illustratively shown in FIG. 6. More particularly, the wireless transmitter 42a′ may include a spread spectrum modulator 44a′ and the wireless receiver 80a′ may include a spread spectrum demodulator 81a′. The spread spectrum may be either direct sequence or frequency hopping as will be appreciated by those skilled in the art. As will also be appreciated by those skilled in the art, multiple such spread spectrum communications links can be operated adjacent one another, as in adjacent cinemas 21a-21d, without causing undesirable mutual interference.

The RF spread spectrum wireless transmitter 42a′ and wireless receiver 80a′ may also preferably operate in an unlicensed band, such as the 2.400 to 2.4835 GHz ISM band. The wireless link may be the same as or similar to those used for wireless LANs (WLANs) operating in accordance with the 802.11 standard as will be appreciated by those skilled in the art. As will also be understood by those skilled in the art, other unlicensed bands are also available. Operation in an unlicensed band offers the advantage of not requiring application for and approval of government operating licenses for the cineplex.

Turning now to FIG. 7, another embodiment of wireless communications link is explained. In this embodiment, the wireless transmitter 42a″ includes a selectable channel RF modulator 44a″. Correspondingly, the wireless receiver 80a″ includes a selectable channel RF demodulator 81a″ that is set to the same channel as the transmitter. Accordingly, operation at different frequencies, or at different polarizations or other codings, for example, can be used to provide multiple channels within the cineplex 20 that are less likely to interfere with one another. Of course, those of skill in the art will appreciate other equivalent wireless communications schemes that provide reduced interference, but provide the advantages of wireless communications.

One method aspect in accordance with the invention is for providing supplemental audio content during playing of a motion picture film including identification data thereon. The method preferably comprises generating time tagged identification data based upon a clock and the identification data from the motion picture film during playing thereof, and synchronizing playing of the supplemental audio content with playing of the motion picture film and based upon the time tagged identification data. Synchronizing may comprise playing the supplemental audio content at a play rate based upon the time tagged identification data to synchronize with playing of the motion picture film. In addition, synchronizing may skip ahead or wait while playing the supplemental audio content based upon the time tagged identification data to synchronize with playing of the motion picture film.

Another method aspect of the invention is for delivering supplemental audio content to at least one movie patron during playing of a motion picture film and associated soundtrack in a cinema of cineplex 20 comprising a plurality of individual cinemas 21a-21d. The method may include providing at least one movie patron unit 50a comprising an earphone 70a and a wireless receiver 80a connected thereto, and wirelessly transmitting the supplemental audio content from a wireless transmitter to the at least one movie patron unit 50a to thereby deliver supplemental audio content to the at least one movie patron. Moreover, the wireless transmitter and wireless receiver 42a, 80a (FIG. 5); 42′, 80a′ (FIG. 6); and 42a″, 80a″ (FIG. 7) may have operating characteristics to avoid interference with respective supplemental audio content systems for other cinemas of the cineplex 20 (FIG. 1).

In addition, other features relating to supplemental audio content systems are disclosed in copending patent application filed concurrently herewith and assigned to the assignee of the present invention and entitled SUPPLEMENTAL AUDIO CONTENT SYSTEM FOR A CINEMA AND RELATED METHODS, attorney work docket number 51220, the entire disclosure of which is incorporated herein in its entirety by reference. Therefore, it is to be understood that the invention is not to be limited to the specific embodiments disclosed, and that modifications and embodiments are intended to be included within the scope of the appended claims.

That which is claimed is:

1. A supplemental audio content system for providing supplemental audio content to at least one movie patron during playing of a motion picture film and associated soundtrack in a cinema of cineplex comprising a plurality of individual cinemas, the supplemental audio content system comprising:
a supplemental audio content player for playing supplemental audio content during playing of the motion picture and associated soundtrack;
a wireless transmitter connected to said supplemental audio content player;
at least one earphone to be worn by the at least one movie patron; and
at least one wireless receiver connected to said at least one earphone and cooperating with said wireless transmitter to deliver supplemental audio content to the at least one movie patron;
said wireless transmitter and wireless receiver having operating characteristics to avoid interference with respective supplemental audio content systems for other cinemas of the cineplex.

2. A supplemental audio content system according to claim 1 wherein the supplemental audio content comprises spoken words devoid of music and sound effects.

3. A supplemental audio content system according to claim 1 wherein the supplemental audio content comprises alternate language audio content.

4. A supplemental audio content system according to claim 1 wherein the supplemental audio content comprises descriptive narrative audio content.

5. A supplemental audio content system according to claim 1 wherein said wireless transmitter comprises a digital modulator; and wherein said at least one wireless receiver comprises a digital demodulator.

6. A supplemental audio content system according to claim 1 wherein said wireless transmitter comprises a spread spectrum modulator; and wherein said at least one wireless receiver comprises a spread spectrum demodulator.

7. A supplemental audio content system according to claim 6 wherein said spread spectrum modulator uses direct sequence spread spectrum modulation; and wherein said spread spectrum demodulator uses direct sequence spread spectrum demodulation.

8. A supplemental audio content system according to claim 6 wherein said spread spectrum modulation uses frequency hopping spread spectrum modulation; and wherein said spread spectrum demodulator uses frequency hopping spread spectrum demodulation.

9. A supplemental audio content system according to claim 1 wherein said wireless transmitter and said at least one wireless receiver use at least one selectable channel.

10. A supplemental audio content system according to claim 9 wherein the at least one selectable channel comprises at least one selectable radio frequency channel.

11. A supplemental audio content system according to claim 1 wherein said wireless transmitter comprises a radio frequency (RF) transmitter; and wherein said at least one wireless receiver comprises at least one RF receiver.

12. A supplemental audio content system according to claim 11 wherein said RF transmitter and at least one RF receiver operate in an unlicensed RF band.

13. A supplemental audio content system according to claim 11 wherein said RF transmitter and said at least one RF receiver operate in a range of about 2.400 to 2.4835 Ghz.

14. A supplemental audio content system according to claim 1 wherein said wireless transmitter comprises an infrared transmitter; and wherein said at least one wireless receiver comprises at least one infrared receiver.

15. A supplemental audio content system according to claim 1 wherein said at least one wireless receiver comprises a respective wireless receiver for each at least one earphone.

16. A supplemental audio content system according to claim 1 further comprising at least one earphone level control connected to said at least one earphone.

17. A supplemental audio content system according to claim 1 wherein said at least one earphone comprises at least one open field earphone.

18. A supplemental audio content system according to claim 1 wherein said supplemental audio content player comprises:
a storage device for storing the supplemental audio content; and
a processor for reading the supplemental audio content from said storage device during playing of the motion picture and associated soundtrack.

19. A supplemental audio content system for providing supplemental audio content to at least one movie patron during playing of a motion picture film and associated soundtrack in a cinema of cineplex comprising a plurality of individual cinemas, the supplemental audio content system comprising:
a supplemental audio content player for playing supplemental audio content during playing of the motion picture and associated soundtrack;
a wireless transmitter connected to said supplemental audio content player; and
at least one movie patron unit comprising an earphone and a wireless receiver connected thereto and cooperating with said wireless transmitter to deliver supplemental audio content to the at least one movie patron;
said wireless transmitter and wireless receiver comprising a digital modulator and a digital demodulator respectively to avoid interference with respective supplemental audio content systems for other cinemas of the cineplex.

20. A supplemental audio content system according to claim 19 wherein the supplemental audio content comprises spoken words devoid of music and sound effects.

21. A supplemental audio content system according to claim 19 wherein the supplemental audio content comprises alternate language audio content.

22. A supplemental audio content system according to claim 19 wherein the supplemental audio content comprises descriptive narrative audio content.

23. A supplemental audio content system according to claim 19 wherein said digital modulator uses direct sequence spread spectrum modulation; and wherein said digital demodulator uses direct sequence spread spectrum demodulation.

24. A supplemental audio content system according to claim 19 wherein said digital modulator uses frequency hopping spread spectrum modulation; and wherein said digital demodulator uses frequency hopping spread spectrum demodulation.

25. A supplemental audio content system according to claim 19 wherein said wireless transmitter and said at least one wireless receiver use at least one selectable channel.

26. A supplemental audio content system according to claim 25 wherein the at least one selectable channel comprises at least one selectable radio frequency channel.

27. A supplemental audio content system according to claim 19 wherein said wireless transmitter comprises a radio frequency (RF) transmitter; and wherein said at least one wireless receiver comprises at least one RF receiver.

28. A supplemental audio content system according to claim 19 wherein said wireless transmitter comprises an infrared transmitter; and wherein said at least one wireless receiver comprises at least one infrared receiver.

29. A supplemental audio content system according to claim 19 wherein said movie patron unit further comprises an earphone level control connected to said earphone.

30. A supplemental audio content system according to claim 19 wherein said earphone comprises an open field earphone.

31. A supplemental audio content system according to claim 19 wherein said supplemental audio content player comprises:
a storage device for storing the supplemental audio content; and
a processor for reading the supplemental audio content from said storage device during playing of the motion picture and associated soundtrack.

32. A supplemental audio content system for providing supplemental audio content to at least one movie patron during playing of a motion picture film and associated soundtrack in a cinema of cineplex comprising a plurality of individual cinemas, the supplemental audio content system comprising:
a supplemental audio content player for playing supplemental audio content during playing of the motion picture and associated soundtrack;
a wireless transmitter connected to said supplemental audio content player;
at least one earphone to be worn by the at least one movie patron; and
at least one wireless receiver connected to said at least one earphone and cooperating with said wireless transmitter to deliver supplemental audio content to the at least one movie patron;
said wireless transmitter and wireless receiver comprising a spread spectrum modulator and a spread spectrum demodulator respectively.

33. A supplemental audio content system according to claim 32 wherein the supplemental audio content comprises spoken words devoid of music and sound effects.

34. A supplemental audio content system according to claim 32 wherein the supplemental audio content comprises alternate language audio content.

35. A supplemental audio content system according to claim 32 wherein the supplemental audio content comprises descriptive narrative audio content.

36. A supplemental audio content system according to claim 32 wherein said spread spectrum modulator uses direct sequence spread spectrum modulation; and wherein said spread spectrum demodulator uses direct sequence spread spectrum demodulation.

37. A supplemental audio content system according to claim 32 wherein said spread spectrum modulator uses frequency hopping spread spectrum modulation; and wherein said spread spectrum demodulator uses frequency hopping spread spectrum demodulation.

38. A supplemental audio content system according to claim 32 wherein said wireless transmitter comprises a radio frequency (RF) transmitter; and wherein said at least one wireless receiver comprises at least one RF receiver.

39. A supplemental audio content system according to claim 38 wherein said RF transmitter and at least one RF receiver operate in an unlicensed RF band.

40. A supplemental audio content system according to claim 38 wherein said RF transmitter and said at least one RF receiver operate in a range of about 2.400 to 2.4835 Ghz.

41. A supplemental audio content system according to claim 32 further comprising at least one earphone level control connected to said at least one earphone.

42. A supplemental audio content system according to claim 32 wherein said at least one earphone comprises at least one open field earphone.

43. A supplemental audio content system according to claim 32 wherein said supplemental audio content player comprises:
a storage device for storing the supplemental audio content; and
a processor for reading the supplemental audio content from said storage device during playing of the motion picture and associated soundtrack.

44. A supplemental audio content system for providing supplemental audio content to at least one movie patron during playing of a motion picture film and associated soundtrack in a cinema of cineplex comprising a plurality of individual cinemas, the supplemental audio content system comprising:
a supplemental audio content player for playing supplemental audio content during playing of the motion picture and associated soundtrack;
an infrared transmitter connected to said supplemental audio content player;
at least one earphone to be worn by the at least one movie patron; and
at least one infrared receiver connected to said at least one earphone and cooperating with said wireless transmitter to deliver supplemental audio content to the at least one movie patron.

45. A supplemental audio content system according to claim 44 wherein the supplemental audio content comprises spoken words devoid of music and sound effects.

46. A supplemental audio content system according to claim 44 wherein the supplemental audio content comprises alternate language audio content.

47. A supplemental audio content system according to claim 44 wherein the supplemental audio content comprises descriptive narrative audio content.

48. A supplemental audio content system according to claim 44 further comprising at least one earphone level control connected to said at least one earphone.

49. A supplemental audio content system according to claim 44 wherein said at least one earphone comprises at least one open field earphone.

50. A supplemental audio content system according to claim 44 wherein said supplemental audio content player comprises:
a storage device for storing the supplemental audio content; and
a processor for reading the supplemental audio content from said storage device during playing of the motion picture and associated soundtrack.

51. A method for delivering supplemental audio content to at least one movie patron during playing of a motion picture film and associated soundtrack in a cinema of cineplex comprising a plurality of individual cinemas, the method comprising:
providing at least one movie patron unit comprising an earphone and a wireless receiver connected thereto; and
wirelessly transmitting the supplemental audio content from a wireless transmitter to the at least one movie patron unit to thereby deliver supplemental audio content to the at least one movie patron;
the wireless transmitter and wireless receiver having operating characteristics to avoid interference with respective supplemental audio content systems for other cinemas of the cineplex.

52. A method according to claim 51 wherein the supplemental audio content comprises spoken words devoid of music and sound effects.

53. A method according to claim 51 wherein the supplemental audio content comprises alternate language audio content.

54. A method according to claim 51 wherein the supplemental audio content comprises descriptive narrative audio content.

55. A method according to claim 51 wherein the wireless transmitter uses digital modulation; and wherein the at least one wireless receiver uses digital demodulation.

56. A method according to claim 51 wherein the wireless transmitter uses spread spectrum modulation; and wherein the at least one wireless receiver uses spread spectrum demodulation.

57. A method according to claim 56 wherein the spread spectrum modulation comprises direct sequence spread spectrum modulation; and wherein the spread spectrum demodulation comprises direct sequence spread spectrum demodulation.

58. A method according to claim 56 wherein the spread spectrum modulation comprises frequency hopping spread spectrum modulation; and wherein the spread spectrum demodulation comprises frequency hopping spread spectrum demodulation.

59. A method according to claim 51 wherein the wireless transmitter and the at least one wireless receiver use at least one selectable channel.

60. A method according to claim 59 wherein the at least one selectable channel comprises at least one selectable radio frequency channel.

61. A method according to claim 51 wherein the wireless transmitter comprises a radio frequency RF transmitter; and wherein the at least one wireless receiver comprises at least one RF receiver.

62. A method according to claim 51 wherein the wireless transmitter comprises an infrared transmitter; and wherein the at least one wireless receiver comprises at least one infrared receiver.

63. A method according to claim 51 wherein the movie patron unit further comprises an earphone level control connected to the earphone.

64. A method according to claim 51 wherein the earphone comprises an open field earphone.
